(19) United States
(12) Patent Application Publication
(10) Pub. No.: US 2023/0267335 A1
(43) Pub. Date: Aug. 24, 2023

(54) SELF-SUPERVISED MULTI-SENSOR TRAINING AND SCENE ADAPTATION

(71) Applicant: A.I. NEURAY LABS LTD., Rosh Haayin (IL)

(72) Inventors: Alon NITZAN, Rosh Haayin (IL); Yotam NITZAN, Tel Aviv (IL)

(73) Assignee: A.I. NEURAY LABS LTD., Rosh Haayin (IL)

(21) Appl. No.: 18/005,232

(22) PCT Filed: Jul. 13, 2021
(86) PCT No.: PCT/IL2021/050856

§ 371 Date: Jan. 12, 2023

Related U.S. Application Data
(60) Provisional application No. 63/151,839, filed on Feb. 22, 2021.
(60) Provisional application No. 62/705,715, filed on Jul. 13, 2020.

(51) Int. Cl. G06N 3/0895; G06N 3/045

(52) U.S. Cl. CPC G06N 3/0895; G06N 3/045

(57) ABSTRACT

A sensing system including at least a first sensor sensing first data from a scene, at least a second sensor sensing second data from the scene, a first teacher/student machine learning subsystem employable by the first sensor to process the first data and a second student/teacher machine learning subsystem employable by the second sensor to process the second data, the first teacher/student machine learning subsystem being operative to teach the second student/teacher machine learning subsystem in a first instance, and the second student/teacher machine learning subsystem being operative to teach the first teacher/student machine learning subsystem in a second instance.

### REFERENCE TO RELATED APPLICATIONS

Reference is hereby made to U.S. Provisional Patent Application Nos. 62/705,715 and 63/151,839, both entitled SELF-SUPERVISED MULTI-SENSOR TRAINING AND SCENE ADAPTATION, respectively filed Jul. 13, 2020 and Feb. 22, 2021, the disclosures of which are hereby incorporated by reference and priorities of which are hereby claimed pursuant to 37 CFR 1.78(a)(4) and (5)(i).

### FIELD OF EMBODIMENTS OF THE INVENTION

The present invention relates to systems and methods for machine learning-based sensing and scene analysis. Within the framework of the present invention, a novel concept of sensors' and analyzers' mutual knowledge distillation and scene adaptation is presented. Generally, in accordance with preferred embodiments of the present invention, a sensor is supervised by at least another sensor during an adaptation period to a specific scene utilizing state-of-the-art Machine Learning subsystems. The supervision role between sensors, possibly from different domains, then alternates with respect to one another until optimal performance/results are achieved or as needed during the operation sequence. In one embodiment of the present invention, such role reversal between the sensors may be used to build reliable, automatically annotated data sets.

### BACKGROUND

Various types of machine learning-based systems for sensor analysis are known in the art.

### SUMMARY OF EMBODIMENTS

The present invention provides novel systems and methods for multi-sensor training and scene adaptation based on interchanging student/teacher relationships between machine learning subsystems employable by sensors sensing data from a scene. Furthermore, the present invention provides novel machine learning architectures, employable in combination with the multi-sensor systems of the present invention, or in other contexts.

Machine Learning is an emerging area of research and development. The year 2012, in which an Artificial Neural Networks (ANN) achieved state-of-the-art performance in the commonly researched task of image classification, marks a turning point. Since then, extensive research and development were done in the field, achieving state-of-the-art performance in a wide variety of tasks. Nevertheless, there are still many challenges in taking this emerging technology into an operational system. A main obstacle in implementing the technology in different applications is the lack of relevant datasets that are required for the training of the Artificial Neural Networks. This difficulty becomes a showstopper when the dataset required for training is site-specific and/or sensor specific, or in the cases that a site-specific and/or sensor specific dataset could improve performance over the current level, and make the use of the system feasible. The invention described herein relates to systems and methods that resolve at least the aforementioned obstacles in many implementations and systems. The invention described herein presents a generic system and method and further presents different types of systems and methods developed under the generic system and method. Description of the systems and methods derived from the generic concept is used to further explain aspects of the invention and shall be understood as also relating to the presentation of the generic concept, which applies to a variety of sensors and analyzers employed for sensing in an outdoor and indoor environment. The sensors may be, but are not necessarily, employed for remote sensing.

Indoor sensing and scene analysis, which may but does not necessarily involve remote sensing, is acknowledged to be useful for a wide range of operation, control, safety, and security applications, such as indoor surveillance and telecommunication link control. The analysis has usually been conducted by a camera. The camera signal is arguably the most researched form of a digital signal and achieves incredibly high performance in many fields and tasks. Nevertheless, cameras also pose problems, such as privacy violations, especially in a private indoor environment (e.g., a household) and limited success in low light conditions and darkness. In recent years the use of other sensors such as radar has emerged into indoor household sensing as an alternative. Sensors, such as radar, suffer from many difficulties when operating in an indoor condition due to issues such as sidelobes and multi-passes that interfere with the signal processing and analysis.

The use of non-intrusive sensors such as radar and lidar activates electromagnetic radiation that is undesired by many users, particularly indoor users. Therefore, a passive sensor such as passive radar is a preferable type of sensor as it is a non-intrusive sensor that uses existing radiating sources, such as Wi-Fi, instead of emitting radiation itself. Although the concept of passive radar is well known for many years, the challenge remains with regards to performance inferiority compared to camera performance in a variety of tasks. This is especially true in the case of a system alert when an event requires further investigation. Passive radar uses widely available existing radiation, for instance, Wi-Fi, 3G, LTE, etc. But, the analysis of the scene and performance by these radars shows limited success and thus is not in commercial use to date, to the best of the knowledge of the present inventors.

This invention presents novel systems and methods for improving the performance of a wide variety of sensors, particularly of radar and especially of passive radar. It is understood that the systems and methods of the present invention are often described in this document in the context of radar, due to the particular utility of the present invention therewith. However, the present invention is not limited to use with radar and may be implemented with any type of sensor employable for sensing properties of a scene, which scene may include one or more objects or entities, either remotely or non-remotely. The systems and methods include an Analyzer, a component for scene analysis that utilizes at least two sensors such as a camera and a radar. The first sensor may employ a pre-trained Machine Learning (ML) subsystem with high performance under specific conditions. For example, in the case that the first sensor is a camera sensor, the ML subsystem employed by the camera sensor may have high performance under good lighting conditions. The first ML subsystem employable by the first sensor, such as the camera sensor, may be termed a first teacher/student ML subsystem, due to the teacher and student functionalities thereof, as is further detailed henceforth.

The second sensor, for example the radar, includes an additional ML subsystem having capabilities that are achieved after training on a vast generic household environment dataset, in addition to “classic”, not-learned, capabilities which are used on radar signal for many years. The second ML subsystem employable by the second sensor, such as the radar, may be termed a second student/teacher ML subsystem, due to the student and teacher functionalities thereof, as is further detailed henceforth.

When the Analyzer is activated and employs the sensors, the system produces vast amounts of invaluable data from both sensors. In the case of camera and radar, the radar ML subsystem is preferably trained with vast, site-specific data, supervised by the high-performance camera ML subsystem. In this instance, the camera ML subsystem acts as a teacher subsystem, teaching the student ML subsystem of the radar. Once good radar performance is achieved, the camera sensor transfers to an idle state and stops capturing images of the scene. Alternatively, the camera may move to a privacy protection mode of operation that generates blurred images by hardware means (e.g., by switching to a blurring lens) or by software. It is noted that in this description, training and/or supervising by and/or of an ML subsystem of a sensor is also referred to interchangeably as training and/or supervising by and/or of the sensor itself.

In more detail, state-of-the-art ML subsystem for camera provides recognition of walls and floor as well as recognition of furniture, human beings, pets and face recognition, the state of the human being (e.g. walking, seated), categorize movement, etc. Generally, a camera that was trained off-line, using a vast generic dataset, can provide good performance. Nevertheless, as detailed below, at some point or recurring points in the site adaptation process, the radar ML subsystem may supervise the training of the camera's ML subsystem for specific tasks, for instance: range estimation and micro-movement recognition as a result of the micro-Doppler analysis. In such instances, the radar ML subsystem acts as a teacher subsystem, teaching the now-turned student ML subsystem of the camera.

The first instance, in which the first sensor ML subsystem teaches the second sensor ML subsystem and the second instance, in which the second sensor ML subsystem teaches the first sensor ML subsystem, may occur sequentially, at least partially concurrently, or repeatedly over a time period, in a dynamically interchanging manner.

It is appreciated that the present invention is not limited to including only two sensors and only two ML subsystems employable thereby. Rather, the present invention may include more than two sensors and more than two ML subsystems employable thereby. For example, the sensing system of the present invention may include at least one additional student/teacher machine learning subsystem, the at least one additional student/teacher ML subsystem being operative to be taught by the first teacher/student ML subsystems in a third instance and being operative to teach the second student/teacher ML subsystem in a fourth instance. It is contemplated that the present invention may include yet further additional student/teacher and/or teacher/student ML subsystems interacting with the other ML subsystems interchangeably as student ML subsystems and teacher ML subsystems. As said, state-of-the-art radar's ML subsystem for object classification and for other analysis tasks provides limited and basic outcomes. The main reason is the lack of a sufficient labeled dataset. Recent works that are considered as the state-of-the-art used datasets of a few thousand labeled radar images, in comparison to the visual (camera) datasets that are available with hundreds of thousands of labeled images and even millions of labeled images. Due to the size of the dataset, just a simple Artificial Neural Network could be implicated resulting in basic performance only based on a small dataset.

However, generally, there are many limitations in obtaining a valid dataset for the radar and more specifically as it is site-dependent due to side lobe, multi-passes, and other interferences.

The present invention solves the limitations in radar machine learning object classification and analysis through the use of novel systems and methods that involve training the radar ML subsystem by the camera's ML subsystem using a huge dataset that has no limits in size. In practical implementation, even one million or more labeled site-specific radar images could be used.

This reach and vast site-specific dataset of the present invention enable the design and construction of a novel well-trained radar ML subsystem with state-of-the-art performance, making the analyzer and the entire system of the present invention a leading and reliable system and technology.

Additionally, the present invention has the ability to produce natural images from the radar signal, inferring information that is usually associated with cameras only, such as texture and colors. Generative Models such as Autoregressive Models (AR), Variational Autoencoders (VAE), Normalizing Flows (NF) and Generative Adversarial Network (GAN) and specifically their conditional counterparts—cAR, cVAE, cNF and cGAN have recently revolutionized content generation capabilities, and lead to immense interest in academia and industry alike. The present invention harnesses and improves upon recent advances. In the present invention, a conditional Generative Model is trained to translate radar signals to natural images using the vast paired dataset collected by the system.

The present invention also presents the above capabilities to an analyzer that incorporates the camera and passive radar. Passive radar is a radar that relies on radiation generated by other systems or devices such as Wi-Fi, cellular systems, and more.

Passive radar performance is highly dependent on the location of the radiation source, type of radiation source, radiation and communication protocol, etc. Hence it is highly difficult to obtain a reliable output from a passive radar in an unknown location, as expected from the analyzer. Therefore, the supervision of the camera, in this case, is essential for providing good and reliable performance of the passive radar. Furthermore, once the passive radar is trained then the system and the analyzer may switch the camera off and the entire analyzer may become passive, thereby maintaining privacy while providing high performance without radiation.

Moreover, the radar, the analyzer, or the system may reactivate the camera in case of degradation in performance. Degradation in performance can occur when several events occur in the scene for the first time and the radar and analyzer encounter performance degeneration. In this scenario, the analyzer reactivates the camera, and the training restarts until the new events are learned and the analyzer and system regain high performance. This process could be controlled by the user or operator of the system in order to avoid activating the camera in a situation and/or at times that are not convenient for the humans in the scene being monitored.

Another embodiment of the analyzer of the present invention is an analyzer that is incorporated into a Wi-Fi repeater that is used for providing Wi-Fi coverage in areas with weak Wi-Fi reception. Is such an embodiment the analyzer comprises at least two sensors and the repeater. An advantage of this configuration is in the analyzer design, which enables synchronization between the signal radiated from the repeater and the radar. Additionally, the synchronized Wi-Fi radiation could be used in a configuration that uses passive radar as the in-device synchronization will improve the passive radar performance. Alternatively, the combined analyzer/repeater can employ the Wi-Fi radiation when the analyzer, based on indication, from the radar seen a human in the scene, and Wi-Fi is activated for supporting the communication needs of the human.

Further, the passive radar can request the analyzer to activate the Wi-Fi for generating additional radiation for supporting its sensing under difficult scenarios. Thereafter, the passive radar becomes an active radar.

There is thus provided in accordance with a preferred embodiment of the present invention a sensing system including at least a first sensor sensing first data from a scene, at least a second sensor sensing second data from the scene, a first teacher/student machine learning subsystem employable by the first sensor to process the first data and a second student/teacher machine learning subsystem employable by the second sensor to process the second data, the first teacher/student machine learning subsystem being operative to teach the second student/teacher machine learning subsystem in a first instance, and the second student/teacher machine learning subsystem being operative to teach the first teacher/student machine learning subsystem in a second instance.

Preferably, the first and second instances occur at least one of sequentially, partially concurrently and repeatedly over time.

In accordance with one preferred embodiment of the present invention, the sensing system also includes at least one additional student/teacher machine learning subsystem, the first teacher/student machine learning subsystem being operative to teach the at least one additional student/teacher machine learning subsystem in a third instance, the at least one additional student/teacher machine learning subsystem being operative to teach the second student/teacher machine learning subsystem in a fourth instance.

Preferably, upon the second student/teacher machine learning subsystem achieving a pre-determined performance, the first sensor is deactivated and the first teacher/student machine learning subsystem is operative to stop teaching the second student/teacher machine learning subsystem.

In accordance with another preferred embodiment of the present invention, in the first instance, the first teacher/student machine learning subsystem is operative to teach the second student/teacher machine learning subsystem to automatically label the second data and, in the second instance, the second student/teacher machine learning subsystem is operative to teach the first teacher/student machine learning subsystem to automatically label the first data, the first and second data being mutually calibrated with respect to one another in each of the first and second instances.

Preferably, the at least first and second sensors include mutually different types of sensors.

Preferably, the at least first and second sensors include at least one of the following: one of the first and second sensors is a camera and the other one of the first and second sensors is an active or passive radar, one of the first and second sensors is an active radar and the other one of the first and second sensors is a passive radar, and one of the first and second sensors is an ultrasound sensor and the other one of the first and second sensors is an ECG sensor.

Preferably, at least one of the at least first and second sensors is a remote sensor.

Preferably, the system also includes a Machine Learning Generative Module, operative to receive the data sensed by one of the first and second sensors and to generate, using machine learning and based on the received data, a generated representation of the scene corresponding to data sensed by the other one of the first and second sensors.

Preferably, the Machine Learning Generative Module includes a Generative Adversarial Network (GAN).

Preferably, the GAN is a conditional GAN.

Preferably, the Machine Learning Generative Module includes a generator sub-module operative to receive the data sensed by the one of the first and second sensors and to generate, using machine learning and based on the data sensed by the one of the first and second sensors, the representation of the scene corresponding to the data sensed by the other one of the first and second sensors, and a paired data provider operative to provide to the generator sub-module pairs of mutually corresponding data previously sensed from the scene by the first and second sensors, the generator sub-module being operative to take into account the pairs of mutually corresponding previously sensed data in generating the representation of the scene.

Additionally or alternatively, the Machine Learning Generative Module includes a first generator sub-module operative to receive the data sensed by the one of the first and second sensors and to generate, using machine learning and based on the data sensed by the one of the first and second sensors, the representation of the scene corresponding to the data sensed by the other one of the first and second sensors, and a second generator sub-module operative to receive the representation of the scene generated by the first generator sub-module and the data sensed by the one of the first and second sensors and to generate, using machine learning, a generated refined representation of the scene corresponding to the data sensed by the other one of the first and second sensors, based on the representation of the scene generated by the first generator sub-module and the data sensed by the one of the first and second sensors.

Preferably, the refined representation of the scene generated by the second generator sub-module is newly generated with respect to the representation of the scene generated by the first generator sub-module.

Preferably, the system also includes at least one additional generator sub-module operative to receive the refined representation of the scene generated by the second generator sub-module and the data sensed by the one of the first and second sensors and to generate, using machine learning, a further refined representation of the scene corresponding to the data sensed by the other one of the first and second sensors, based on the refined representation of the scene generated by the second generator sub-module and the data sensed by the one of the first and second sensors.

Preferably, the Machine Learning Generative Module is operative to synthesise labelled training data useful for the training of at least one of the first and second machine learning subsystems.

There is further provided in accordance with another preferred embodiment of the present invention a sensing system including at least a first sensor sensing first data from a scene, at least a second sensor sensing second data from the scene, the first data being of a different type than the second data and a Machine Learning Generative Module including at least one of (i) a generator sub-module operative to receive the first data sensed from the scene and to generate, using machine learning and based on the first data, a representation of the scene corresponding to the second type of data, and a paired data provider operative to provide to the generator sub-module pairs of mutually corresponding first type of data and second type of data previously sensed from the scene, the generator sub-module being operative to take into account the pairs of mutually corresponding previously sensed first and second types of data in generating the representation of the scene, and (ii) a first generator sub-module operative to receive the first data and to generate, using machine learning and based on the first data, a representation of the scene corresponding to the second type of data, and a second generator sub-module operative to receive the representation of the scene generated by the first generator sub-module and the first data and to generate, using machine learning, a refined representation of the scene corresponding to the second type of data, based on the representation of the scene generated by the first generator sub-module and the first data.

Preferably, the Machine Learning Generative Module includes a Generative Adversarial Network (GAN).

Preferably, the system also includes including at least one additional generator sub-module operative to receive the refined representation of the scene generated by the second generator sub-module and the first data and to generate, using machine learning, a further refined representation of the scene corresponding to the second type of data, based on the refined representation of the scene generated by the second generator sub-module and the first data.

Preferably, the system also includes a first teacher/student machine learning subsystem employable by one of the first and second sensors to process the data sensed thereby and a second student/teacher machine learning subsystem employable by the other one of the first and second sensors to process the data sensed thereby the first teacher/student machine learning subsystem being operative to teach the second student/teacher machine learning subsystem in a first instance, and the second student/teacher machine learning subsystem being operative to teach the first teacher/student machine learning subsystem in a second instance.

In accordance with one preferred embodiment of the present invention, the first teacher/student machine learning subsystem is operative to teach the second student/teacher machine learning subsystem to automatically label the second data and, in the second instance, the second student/teacher machine learning subsystem is operative to teach the first teacher/student machine learning subsystem to automatically label the first data, the first and second data being mutually calibrated with respect to one another in each of the first and second instances.

### BRIEF DESCRIPTION OF THE DRAWINGS

FIG. 1, is a schematic illustration of the system and method operating in an indoor environment.

FIG. 2, is a simplified block diagram of the system.

FIG. 3, is a schematic illustration of an analyzer.

FIG. 4, is a schematic illustration of another embodiment of the analyzer that comprises a stationary sensor and a mobile sensor 40, such as a smartphone.

FIG. 5, is a block diagram of an analyzer and its interfaces and communication.

FIG. 6, is a block diagram of an analyzer. In this embodiment, the analyzer includes a camera, a passive radar, a processor, and Wi-Fi communication. Both camera and radar Artificial Inelegance (AI) Engines contain multiple state-of-the-art Machine Learning models (ML models), typically Artificial Neural Networks (ANNs).

FIG. 7, is a simplified and partial flow chart of the training process.

FIG. 8, is a simplified flow-chart of part of the training process which provides further details about the training process and handshakes and relationships between the system components such as analyzer and sensors.

FIG. 9A, is a block diagram depicting the relationship between different sensors within an analyzer.

FIG. 9B, which is a block diagram depicting the relationship between Camera and radar AI Engines. Both Camera and Radar AI Engines contain multiple ML models, typically state-of-the-art ANNs (Artificial Neural networks), responsible for understanding the environment and receiving educated decisions.

FIGS. 10A and 10B are block diagrams further specifying the relationship between the corresponding ML models in the Camera and Radar AI Engines. The figure is divided into two parts which represent the two life-stages of the ML models, with FIG. 10A representing the training process and FIG. 10B representing the inference process.

FIGS. 11A and 11B are schematic illustrations of a process in which initially the camera trains the radar and the radar, in some functionalities trains a sub-network of the camera.

FIG. 12, which is a simplified flow chart of system alarming process and the information generated in a novel process and presented to the user in case of an alarm.

FIGS. 13A and 13B, are block diagrams depicting the novel cdd-haG architecture how this invention uses them.

FIGS. 14A and 14B, are block diagrams depicting an example of implementation of cdd-haG using cGANs for loss computation.

FIGS. 15A and 15B, are block diagrams depicting the novel cddG 2 architecture.

FIG. 16, is a block diagram depicting an example of implementation of cddG 2 using cGAN for loss computation; and

FIG. 17 is a pictorial illustration of another implementation of the sensing system of the present invention.

### DETAILED DESCRIPTION OF EMBODIMENTS

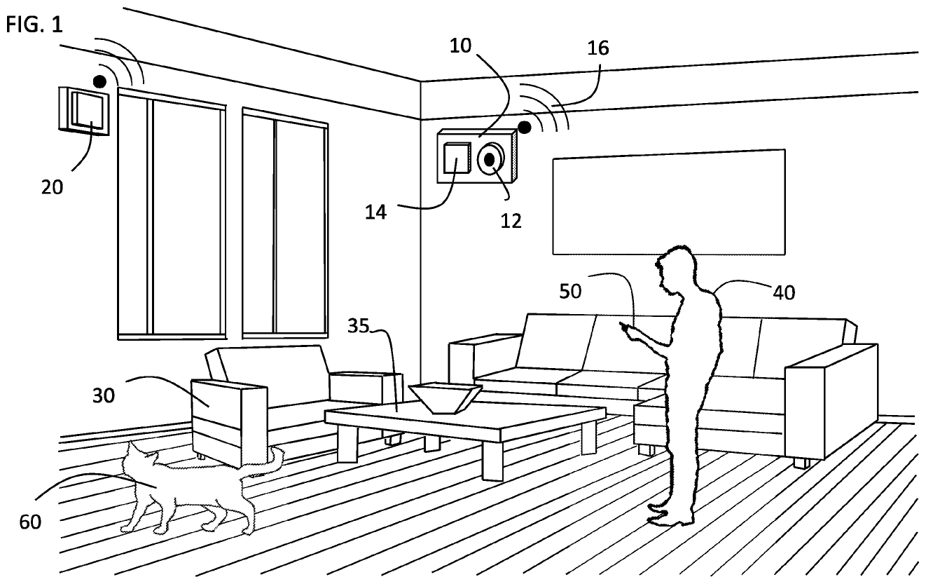

Reference is now made to FIG. 1, which is a schematic illustration of the system and method operating in an indoor environment. One type of an analyzer 10 and a different type of an analyzer 20 are installed in the indoor environment and are monitoring the same volume, partially the same volume of adjacent volumes. In the volume, there are stationary objects such as armchair 30, table 35, and more. Additionally, human 40 is in the monitored volume and the human is operating a mobile phone 50. A pet 60 is also in the monitored volume. The analyzers and 20 are part of a system that includes one or more analyzers that monitor an area or a volume. Before the installation, the analyzers are trained to certain performance levels using machine learning techniques such as Artificial Neural Network, in an offline facility, and by using the best data set available. The said analyzer has at least one sensor. As shown analyzer 10 includes sensor 12 and sensor 14. Sensor 12 has been trained for a certain environment and for performing a variety of tasks. Sensor 14 is a different type of sensor trained to a certain environment and for performing a variety of tasks. For instance, the offline training of sensor 12 before installation caused it, as an example, to perform at an 85% level of performance at the current environment, shown in FIG. 1, while sensor 14 is performing, as an example, to 20% expected performance under the current environment. One of the main challenges in machine learning algorithms is to adapt and generalize to new, unseen, data. This is obviously the case for a system that is pre-trained in a certain facility and then deployed to a completely new, never before seen environment, such as a specific house or office. Further, once deployed, it is only important for the system to operate optimally in this specific new environment. To fulfill this observation, after the activation of the analyzers, we further train them to operate optimally in this new environment using a process of mutual training, with the objectives that both sensors within the analyzer will reach the maximum possible performance e.g. above 99%. Mutual training is a complex process in which different algorithms should improve each other in a symbiotic manner. In the deep learning literature, some research was done in recent years on the “teacher-student” and “knowledge distillation” paradigms, but almost all of it assumes the two algorithms operate on the same data domain and none of it deals with role reversal between the teacher and the student. In our case, the algorithms might operate on different data domains, attained using different sensors. Therefore, making the process especially challenging and novel. Since the sensors are inherently different, it is possible to estimate which sensor would perform better for a certain task. In our example, sensor 12 performs better under the current environment for this task. Hence, in the process of mutual training, sensor 12 initially supervises the training process. Nevertheless, as part of the process, sensor 14 also contributes to the training of sensor 12. During the joint training of sensors 12 and 14, any one of them could serve as teacher and the second as student. It may be the case that the sensors iteratively switch roles, or that both serve as teacher and student at least partially concurrently. It may also be the case that this process of changing roles from teacher to student happens repeatedly over time. The decision to change roles may be caused by either an external indication either by a user or by a change in environment such as sunrise or sunset. It could alternatively be that the subsystems internally reach a decision to change roles, based on the achieved performance, the data collected or hardware and communication requirements. The said training is performed online and/or offline in the analyzer, sensor, locally at the vicinity of the environment, and/or at the cloud. It could be separately in each sensor or as a whole analyzer and system.

The system includes at least one analyzer but generally a plurality of analyzers. The analyzer includes at least two sensors that are collocated in the same enclosure or in separate enclosures. Analyzer 10 comprises two sensors 12 and 14, whereas the analyzer 20 comprises one sensor. The analyzers have a means of communication such as wireless 16 or wired.

In accordance with one preferred embodiment of the present invention, in one instance a first teacher/student machine learning subsystem of one of the sensors, such as a machine learning subsystem employed by sensor 12, may be operative to teach a second student/teacher machine learning subsystem of another one of the sensors, such as a machine learning subsystem employed by sensor 14, to automatically label the data acquired by the second sensor. Such labelling may include automatic annotation of images acquired by the second sensor. In a second instance, the roles of the machine learning subsystems may reverse and the second student/teacher machine learning subsystem of the second sensor, such as sensor 14, may become operative to teach the first teacher/student machine learning subsystem of the first sensor, such as sensor 12, to automatically label the data acquired thereby. Again, such labelling may include automatic annotation of images acquired by the first sensor, now being taught.

In order for the machine learning subsystem employed by one sensor to teach the machine learning subsystem employed by the other sensor to automatically label its own data, the data captured by the two sensors are preferably mutually calibrated with respect to teach other. This allows data captured by one sensor to be used for assisting in the automatic labelling of data captured by the other sensor. Such calibration may involve temporal synchronization and calibration of characteristics of the data captured by the two sensors. For example, the data captured by the two sensors may be temporally synchronized and/or calibrated with respect to spatial, velocity or depth information contained in the data.

By way of example, such a mutual teaching and learning process whereby data acquired by the sensors is automatically labelled, may be used in order to build up a dataset required for further training of one or both of the sensors. For example, analyzer 10, including sensors 12 and 14, may be deployed for data collection at one location. As a result of the automatic labelling exchangedly taught and learned by the machine learning subsystems employed by sensors 12 and 14, labelled data sets useful for the further training of each of the machine learning subsystems employed by sensors 12 and 14 may be produced. Such a labelled data set may then be provided to an additional analyzer, such as analyzer 20, as an initial labelled data set for the further training of an additional machine learning subsystem based thereon.

The system includes different types of sensing capabilities and a variety of analyzing and reporting capabilities. The system has a plurality of Machine Learning modules in which the modules may be in a different state of training. One sensor within one analyzer could be in a pre-trained state, and other analyzers and sensor ML modules are initially or partially trained or fully trained.

The analyzer could be any combination of two or more of the following sensors: camera, night camera, radar, SAR radar, passive radar, Lidar, gated camera, stereo camera, depth camera, thermal camera, microphone, ultrasound sensor, ECG sensor, or any other type of sensor known in the art and suitable for use within the sensor system of the present invention.

The system employs temporal hierarchy or relationship between the analyzers, and in certain system's state, one analyzer or sensor could complete its role and could be shut down. For instance, the camera takes part in the training process and at maturity, it could be shut down for privacy.

The system is shown in an indoor environment, but it could be deployed in an outdoor environment.

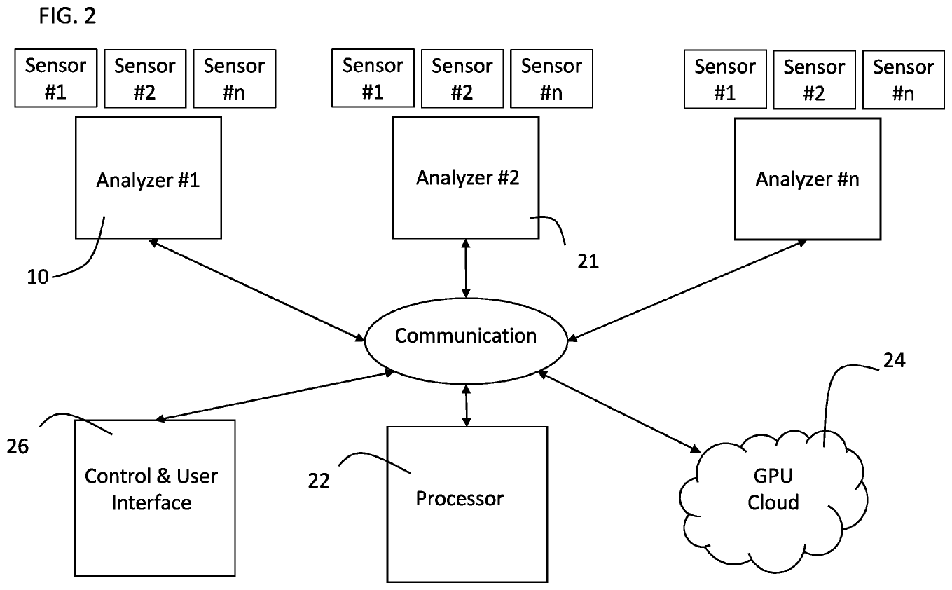

Reference is now made to FIG. 2, which is a simplified block diagram of the system. The system includes at least one analyzer 10 and generally a plurality of analyzers indicated as ‘n’ analysers, wherein each analyzer includes at least one sensor and the system has at least two sensors that, preferably although not necessarily remotely, sense the environment. Each analyzer has communication capabilities and is connected to a processor 22 and as may be necessary to the cloud 24, and also to means of control and user interface 26. The analyzer's machine learning module can employ training capabilities, locally at the analyzer level and as needed can employ training capabilities in the processor that is the vicinity of the analyzer, for instance, in the same house. Additionally, the analyzer can employ training capabilities in the cloud or in any remote server. Training can be performed on any type of hardware such as CPU, GPU, TPU, ASIC, FPGA. Additionally, the user may contribute to the training process by annotating system outputs, filtering out non-representative data samples, sort data samples by importance and providing feedback to the learning process.

Additionally or alternatively, the machine learning subsystems employed by the sensors within each of plurality of analyzers 10-n may alternately teach or learn from each other in order to automatically label or annotate data acquired by each of the sensors, as described hereinabove. Such a process may be used to generate a labelled dataset that may then be provided to another analyzer, for example including only a single sensor of the same or similar type as one of the sensors included in analyzer 10. This labelled data set may then be used as a starting point for the further training of the additional analyzer. As discussed, the main objective is to adapt the sensors to the current environment by mutual training and after a period of time to achieve a performance rate of near 100%. An additional or alternative objective is the provision of one or more labelled datasets, which labelled datasets are generated by automatic labelling. Such automatic labelling may reduce or obviate the need for human labelling of data provided to the analyzer.

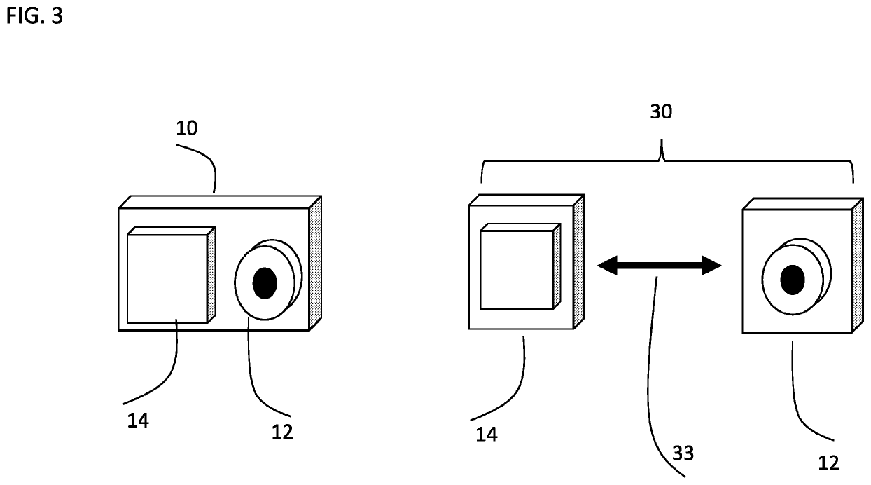

Reference is now made to FIG. 3, which is a schematic illustration of an analyzer 10, each analyzer includes at least two sensors, 12 and 14. The sensors can be collocated in one enclosure as shown in 10 or active in separate enclosures as seen in 30 and communicate directly or indirectly via a communication link 33. The analyzer 10 and 30 include a combination of sensors such as camera, night camera, radar, SAR radar, passive radar, Lidar, gated camera, stereo camera, depth camera, thermal camera, microphone, ultrasound, ECG, etc.

In this embodiment, the analyzer 10 includes a radar or passive radar 14 and a camera 12.

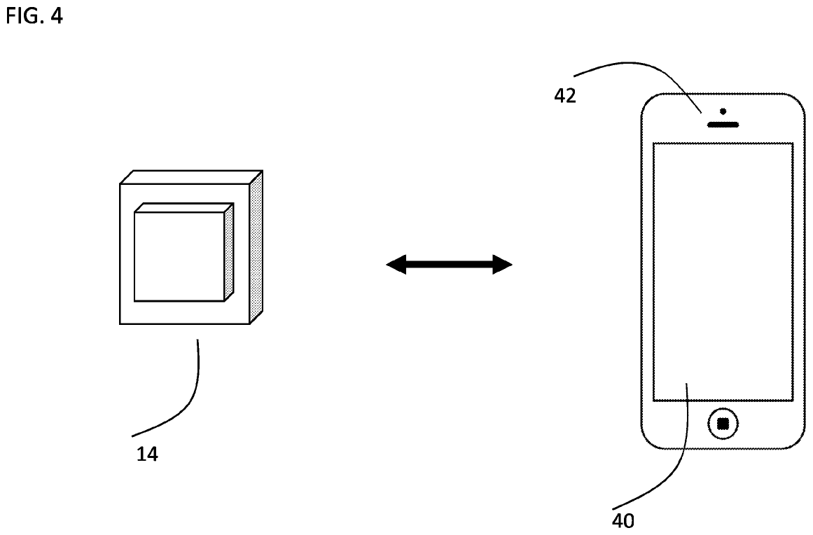

Reference is now made to FIG. 4, which is a schematic illustration of another embodiment of the analyzer that comprises stationary sensor 14 and a mobile sensor 40, such as a smartphone. The analyzer can activate the smartphone and its mobile camera 42 and can use smartphone capabilities such as its mobile network communication 5G, its GPS capabilities, accelerometer, gyroscope, etc.

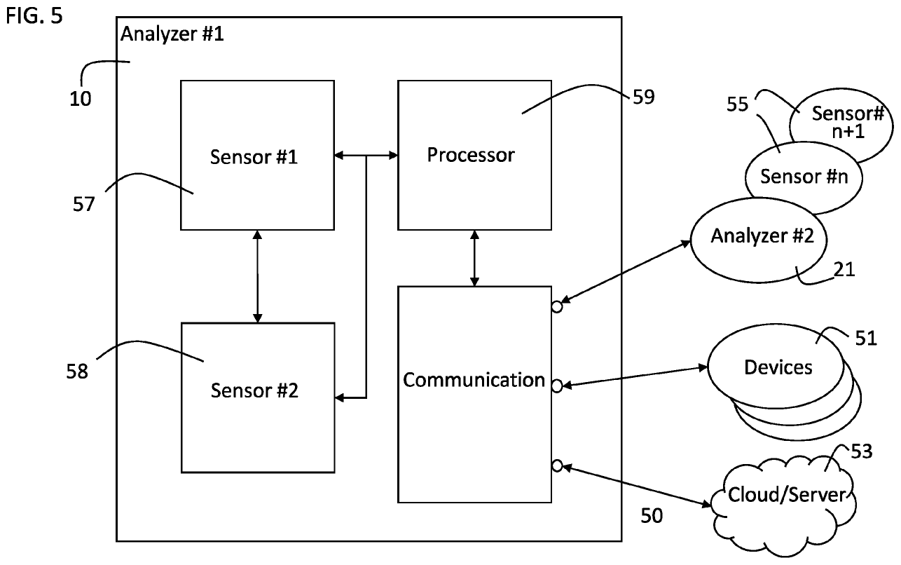

Reference is now made to FIG. 5, which is a block diagram of an analyzer 10 and its interfaces via a communication 50 to the system components such as other analyzers 21, other devices 51, and the cloud/server 53. The analyzer includes at least two sensors 57,58, processing capabilities 59, and communication 50. The analyzer can share, via communication, information, and knowledge with other analyzers 21 or other sensors 55 which are part of other analyzers, other devices 51, such as mobile phones for the system user interface and control, and with the cloud/server 53 for part of the processing. The analyzer includes at least two sensors out of the following: camera, night camera, radar, SAR radar, passive radar, Lidar, gated camera, stereo camera, depth camera, thermal camera, microphone, ultrasound, ECG, or any other appropriate sensor.

The communication 50 is at least one or more of wired or wireless communication. The analyzer is part of a system, and the system provides to its control software and user interface the system status and system alerts as well as setups and inputs from the user using the user interface application. The control and user interface are running on an application that runs on a computer and smartphone at the preference of the user. Each sensor has a different mode of operation that is controlled by the analyzer, by the system and in some cases by the user.

For instance, in one embodiment that sensor #1 is a camera and sensor #2 is a radar. The radar uses a different mode of operations. It could be an active radar or passive radar and, in each case, it could employ different signals and frequencies radiated by the radar or different receiver channels and even different antennas. The radar could be in a MIMO configuration or Beam-Forming configuration. Additionally, in the case of passive radar, the radar can request the analyzer to activate the wireless communication as a means of an additional radiation source that may be needed in some cases for the radar signal processing or for the radar inference as further explained below. Additionally, the analyzer can use part of the communication system information, such as the synchronization frame and use it or provide it to at least one of the sensors for its operation. Or initiate communication's mode that will activate the communication in a way that will support the system processing, such as activation of Wi-Fi beamforming for illuminating a target.

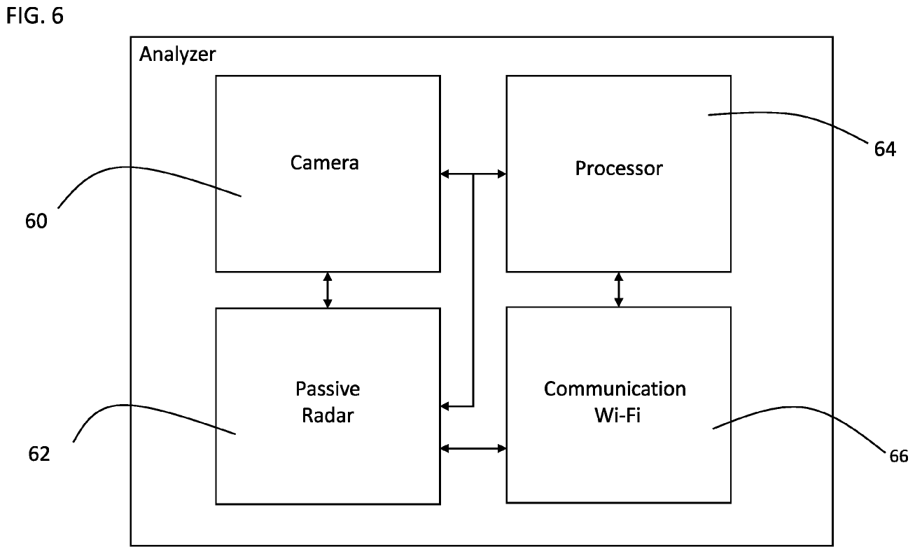

Reference is now made to FIG. 6, which is a block diagram of an analyzer. In this embodiment, the analyzer includes a camera 60, a passive radar 62, a processor 64, and Wi-Fi communication 66. Both camera and radar include and employ ML subsystems. The ML subsystems may be Artificial Intelligence (AI) Engines contain multiple state-of-the-art Machine Learning models (ML models), typically Artificial Neural Networks (ANNs), responsible for understanding the environment and receiving educated decisions. Other types of ML subsystems employable by the sensors of the present invention include Decision Trees, Support Vector Machines (linear or non-linear), Regression analysis (such as but not limited to: linear regression, polynomial regression, logistic regression, kernel regression), Bayesian Networks, Genetic Algorithms, Clustering. Each subsystem may be operable alone, or any multitude of subsystems may be used together as an ensemble, specifically by using boosting methods, to compose a single ML subsystem. It is noted that the various types of ML subsystems may be employed by any of the types of sensors useful in the present invention. The camera AI Engine contains pre-trained ML models that provide the supervision required for the teaching of the parallel radar ML models. This novel idea enables the adaption of the radar AI Engine to the specific environment in which it is employed, thus achieving superior performance. The teaching process includes different functions and objectives, such as setting the radar operation setup, setup of radar internal functions e.g. filters, and training the different ANN within the ML model that enhance the signal image processing capabilities to very high performance Final decisions and if required alerting are obtained using a dedicated data-driven algorithm such as Deep Learning, Decision Trees, etc.

Further, the radar is trained to operate independently, merely supervised by the knowledge of the camera AI Engine, thus allowing the radar to work on its own. This allows, to turn the camera off or blur the camera image to better preserve privacy, while not harming performance. The function of blurring the camera is done by image processing software or by inserting a blurring lens.

In this embodiment, the camera is pre-trained for all its functions to a certain level, part of AI Engine's functions are fully trained, and part of the functions are partially trained or initially trained. After activation of the analyzer, the passive radar sensor has basic passive radar performance such as point cloud returns and Micro-Doppler of moving targets and some initial detection capabilities. However, due to the complex environment and the inherent radar processing issues, such as multi-pass, the performance is not sufficient. Therefore, from the activation of the analyzer the passive radar sensor, and more specifically the radar ML model, such as ANN, CNN, and their sub-networks is under the supervision of the camera's ML model, until state-of-the-art radar performance is achieved. Additionally, after the radar's ML models achieved the best performance, then in part of the functions the radar ML models sub-neural network begins training of the camera ML model sub-network. For instance, the radar micro-doppler ML trains the camera movements ML and range estimation ML. In this handshaking performance, the analyzer converges to ultimate performance. The process in FIG. 6 runs similarly using an active sensor which radiates and also different sensor combinations such as active radar and thermal camera.

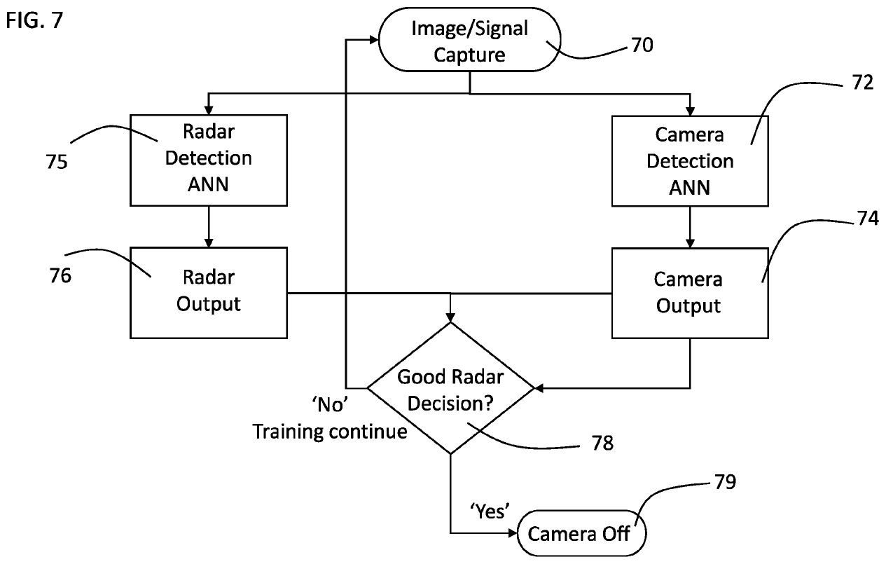

Reference is now made to FIG. 7, which is a simplified and partial flow chart of the training process. In this embodiment, the analyzer includes two sensors, a camera, and a radar. The process is employed similarly with any of the different types of sensors described in this employable within the present invention. The process starts with a simultaneous image/signal capture 70 samples from the two sensors. In this embodiment the Camera Detection ANN 72 is a pre-trained ML model that operates on visual data captured by a camera and performs detection. I.e. detects and classifies objects in the scene. The Radar Detection ANN 75 is an ML model that operates on radar signals, undergoing training, according to the supervision of the camera's ML model. The forward pass of the camera signal through the ANN generates an output 74. This output is either the prediction of the model or any intermediate activation produced by the model. Most notably the intermediate activation could be the “logits” vector. Simultaneously, the radar signal is forwarded through the radar's ANN and produces a corresponding output 76. Both outputs are fed into the performance evaluation process 78, in which the camera's output 74 serves as the ground truth and the radar's output serves as the prediction. The performance evaluation process evaluates the discrepancy between the two outputs using a loss function, which is used to train the radar's ANN. Also, the performance evaluation process decides whether the radar's ANN has achieved satisfactory results, in which case, the training process is terminated.

In accordance with one preferred embodiment of the present invention, the output 74 of the camera detection ANN 72 may be used to teach the radar detection ANN 75 to automatically annotate or label the images acquired by the radar sensor. In this case, the radar output 76 may include images automatically annotated by the radar ANN 75. As described hereinabove, in other instances, the teaching and learning roles of the camera ANN 72 and radar ANN 75 may reverse, and the output 76 of the radar ANN may be used to teach the camera ANN 72 to automatically label the images acquired by the camera. In this case, the camera output 74 may include images automatically annotated by the camera ANN 72.

It is understood that in order for the camera ANN 72 to teach the radar ANN 75 to automatically label images and vice versa, the data captured by the camera and radar is preferably mutually calibrated and synchronized. Such calibration and synchronization may include time synchronization and synchronization of spatial, velocity and depth information.

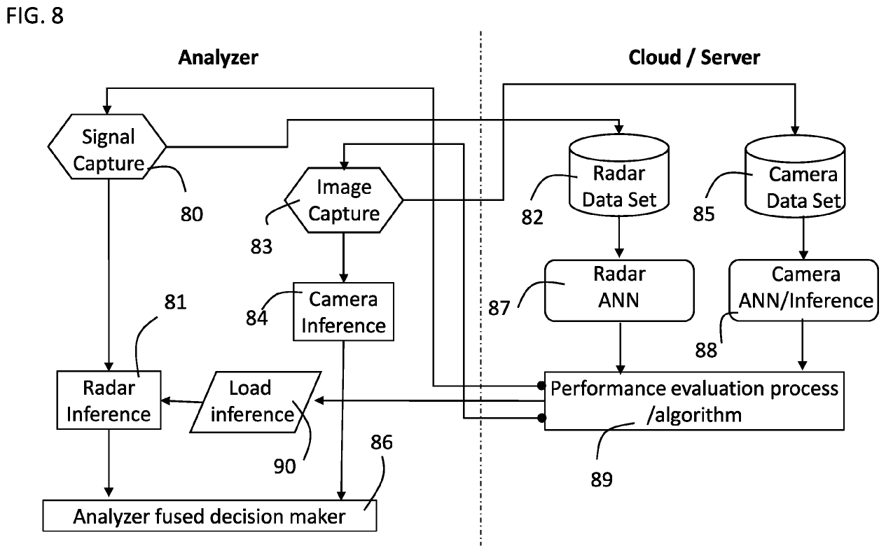

Reference is now made to FIG. 8, which is a simplified flow-chart describing the interaction between system components and specifically the relationship between the inference process and the training process, thus expanding FIG. 7. The inference process is depicted on the left half of the figure, while the training, which was previously described in FIG. 7, is depicted in the right half. The Signal Capture 80 and Image Capture 83 provide their data to the Radar inference 81 and Camera inference 84. From both the radar and camera inference outputs, the final decision is produced by the Analyzer fused decision 86. Since at first, the camera performs superiorly, the Analyze fused decision-maker knows to rely more on its output. Simultaneously to the training phase, the Signal capture and Image capture provide their data to the Radar Dataset 82 and Camera Dataset 85, correspondingly. From these datasets, the Radar ANN 87 is trained using the supervision of the Camera ANN 88, as described in FIG. 7. Once the Radar's ANN has reached satisfactory performance, the Performance Evaluation Process 89 decides to terminate the training process. Now, the Radar ANN is provided to the analyzer, to be used for inference. The Load Inference module 90 converts the Radar ANN to inference mode, which first optimizes the model for inference and then replaces the previously used model. The optimization process may be software and/or hardware-based. Examples of possible optimizations are but not limited to: pruning, quantization, knowledge-distillation, and programming the model to FPGA. These two processes of inference and training are happening simultaneously in an online fashion until it is decided by the system/user that the radar performance has reached stagnation and can't be improved further. At which point, the camera moves to “non-intrusive” mode as previously described, and training of the radar's ANN is stopped.

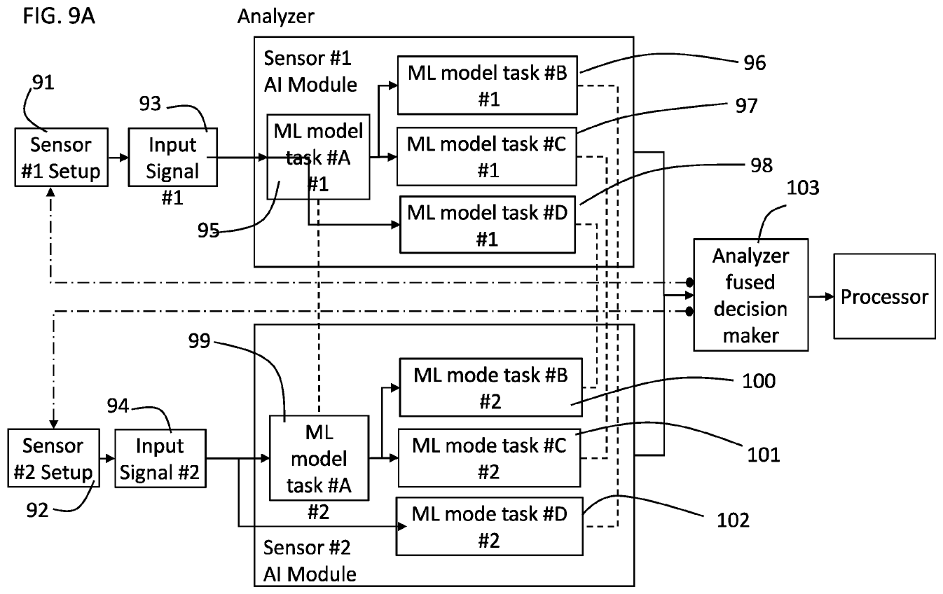

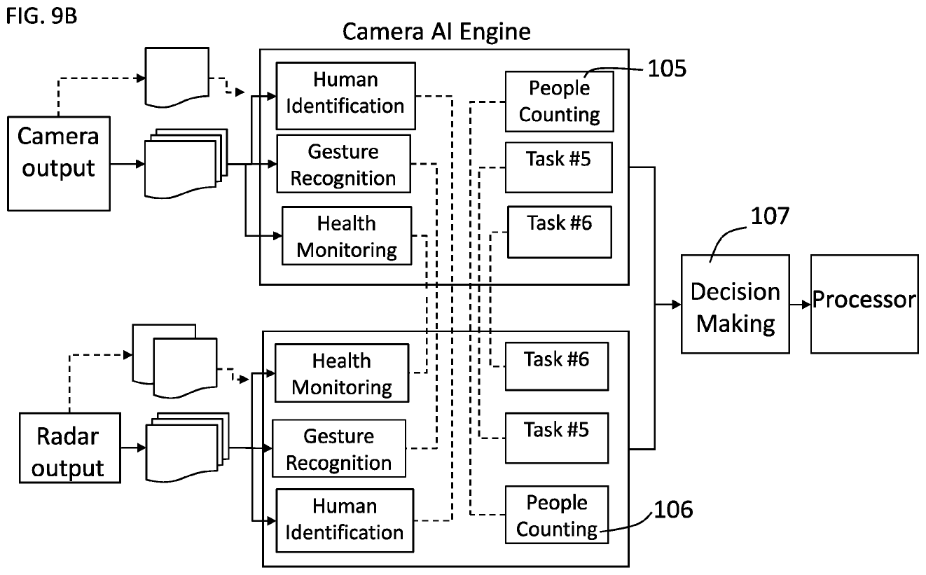

Reference is now made to FIG. 9A, which is a block diagram depicting the relationship between different sensors and their corresponding computational models within an analyzer. Both sensors are set up with specific configurations 91,92. Then, each sensor captures a signal-93,94. The type of signal depends on the type of sensor and its configuration. The analyzer is composed of two AT Engines, one for each sensor. The AI Engine is a multi-task computation unit that performs all the computation required for a single type of signal. Each AI Engine itself is composed of multiple ML models 95-98 for sensor #1, and 99-102 for sensor #2, which are task-specific Machine Learning algorithms, typically ANNs. Typically, ML Models have counterparts ML Models in different AI Engines, hence allowing both knowledge distillation and fused decision making, for instance, ML Model's 95 is the counterpart of ML Models 99. The ML model's function and relationships with other components vary depending on its purpose. For instance, ML models 95,99,98,102 get the raw input signals, whereas ML Models 96,97 and 100,101 get their input from ML Models 95 and 97, respectively. As described in FIG. 8, the Analyzer fused decision maker 103 might get a prediction from two counterparts ML Models and produce the final prediction according to varying considerations, or it might get a single prediction if one of the AI Engines was shut-off.

Reference is now made to FIG. 9B, which is a simplified block diagram depicting the relationship between Camera AI Engine 105 and Radar AI Engine 106, in the specific embodiment in which the two sensors are camera and radar. Both Camera and Radar AI Engines contain multiple ML models, typically state-of-the-art ANNs (Artificial Neural networks), responsible for understanding the environment and making educated decisions. The camera AI Engine contains pre-trained ANNs, that provide the supervision required for the training or fine-tuning of the corresponding radar ANNs. This novel idea enables the adaption of the radar module to the specific environment in which it is employed, thus achieving superior performance. Final decisions are obtained using a dedicated data-driven algorithm 107 such as Deep Learning, Decision Trees, etc.

Further, the radar's ML models are trained to operate independently, merely supervised by the knowledge of the camera module, thus allowing the radar AI Engine to work on its own. This allows, to turn the camera off/blur the camera image to better preserve privacy, while not harming performance.

The camera and radar AI Engines solve multiple challenging tasks, depending on the environment in which the system is deployed. FIG. 9B describes an exemplary design for the system in an indoor environment. First, optical data as a single image or video and a variety of radar data such as points cloud returns, range/micro-doppler are captured using the camera and radar, respectively. The said captured data could be a single sample such as one image or a sequence of images i.e. video for the camera, and a single sample of different radar outputs or a sequence of data outputs samples collected over a window if time generating spectrogram. Then the data is preprocessed according to the task in hand, before being fed to the ML models, each dedicated to solving a specific task. The radar data could be represented either as a raw signal, 3D point cloud, micro-doppler image, spectrogram, etc.

A Few Examples of Tasks are:
Human Identification—Identifies humans based on face image and characteristic motion and behavior.
Gesture Recognition—Recognizes a set of known gestures performed by humans.
Health Monitoring—Monitors the health and safety of humans, specifically elders, and infants.
People Counting—Counts the number of people inside the environment.

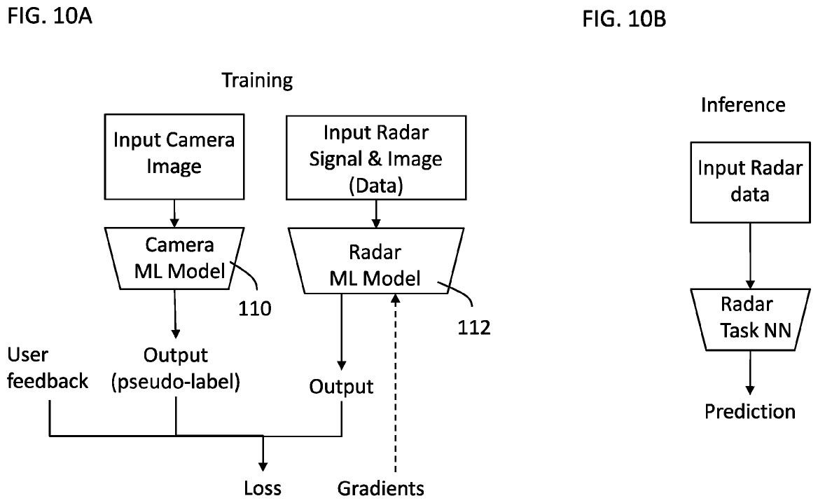

Reference is now made to FIGS. 10A and 10B, which are simplified block diagrams further detailing the relationship between the corresponding ML models in the Camera and Radar AI Engines. The figure is divided into two parts which represent the two life-stages of the ML models, with FIG. 10A representing the training process and FIG. 10B representing the inference process.

During training, an image and radar information are captured at the same time or nearly at the same time and the data is synchronized. Then, as discussed, the signals are preprocessed and forwarded to the Camera ML 110 and Radar ML 112 models, respectively. For each model, the forward process generates an output. This output is either the prediction of the model or any intermediate activation produced by the model. Most notably the intermediate activation could be the “logits” vector. Then, since the camera ML model supervises the training session, its outputs are considered pseudo-labels. A loss value is calculated for the Radar ML Model 112 prediction. The loss is calculated as a function of the difference between the Radar ML Model 112 and the Camera ML Model 110 and a user feedback if such exists. Last, the radar ML model is optimized to better match the output of the Camera's ML Model and the user feedback. When the output is the “logits” vector, this type of training is called “Knowledge distillation”. In recent years, many research papers have the success of Knowledge distillation in minimizing the size of Deep Neural networks. However, to the best of our knowledge, no work has considered the Knowledge distillation as an approach to perform scene adaption of a multi-sensor system capturing inherently different data types. Once the training is completed, the ML Model is deployed in inference mode as described in FIG. 8. In the inference mode, the camera data and ML Model are no longer required, and the radar works on its own. On the hardware side (not shown) the camera circuitry could be turned off by covering the camera lens or the camera can be configured to blur mode by inserting a blurring lens. All these functions aim to preserve privacy. Part of these functions and preferences could be controlled by the user using an application that runs on the user smartphone.

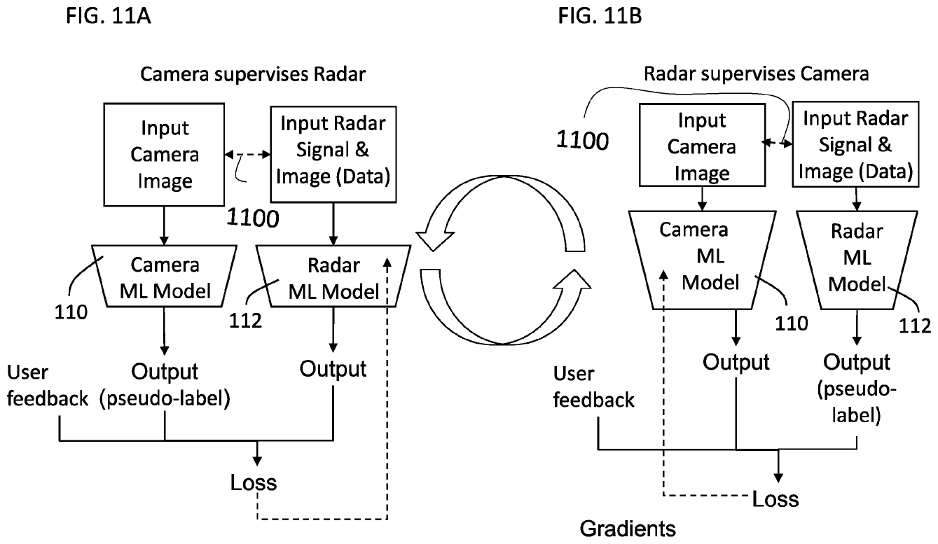

Reference is now made to FIGS. 11A and 11B, which are simplified schematic illustrations of the dynamic relationship between the two possible instances of the system during training. In FIG. 11A, the first instance where a Camera ML Model supervises the training of the Radar ML Model as was depicted in FIG. 10A. It is understood that in the arrangement in FIG. 11A, camera ML model 110 constitutes a first teacher/student machine learning subsystem, employed by the first sensor, here embodied as a camera. Furthermore, Radar ML model 112 constitutes a second student/teacher machine learning subsystem, employed by the second sensor, here embodied as a radar. In the instance shown in FIG. 11A, camera ML model 112 acts as a teacher of student radar ML model 112.

FIG. 11B, depicts the second instance in which the roles are reversed and the Camera ML Models supervises the training of the Camera ML Model. It is understood that in the instance of FIG. 11B, camera ML model 110 now acts as a student, taught by radar ML model 112, which has become the teacher ML system. Such a method of alternating training supervision from one sensor ML to the other sensor ML and vise-versa supports the convergence of the analyzer to ultimate performance, and provides a means for each ML model to improve upon the scenarios in which a specific sensor might encounter difficulties. For example consider the pair of camera and radar sensor, the camera ML model teaches the radar ML Model to handle conditions of high clutter and extreme side-lobes, where the radar ML Models teaches the camera model to operate in low-light and object obstruction. Further by way of example, the camera ML model, in one instance for example as shown in FIG. 11A, may teach the radar ML model to automatically label or annotate the data acquired thereby, based on the automatic annotation of camera images corresponding to and calibrated with respect to the radar data. In this case, the pseudo-labels output by the camera ML model 110 are used to teach the radar ML model to automatically generate its own data labels.

In another instance, for example as shown in FIG. 11B, the radar ML model may teach the camera ML model to automatically label or annotate the data acquired thereby, based on the automatic annotation of radar data corresponding to and calibrated with respect to the camera data. In this case, the pseudo-labels output by the radar ML model 112 may be used to teach the camera ML model to automatically generate its own data labels.

In either case, in order for the camera ML model to teach/learn from the radar ML model, the data acquired by both the camera and radar are preferably mutually calibrated and synchronized. This is indicated by a dashed arrow 1100 in FIGS. 11A and 11B, showing optionally necessary temporal, spatial, depth, velocity or other parameter synchronization between the two data types.

It is appreciated that although the sensors and corresponding ML models or subsystems employed thereby are shown in FIGS. 11A and 11B to be embodied as camera and radar sensors and ML subsystems respectively, wherein the camera ML model acts as a first teacher/student ML subsystem and the radar ML model acts a second student/teacher ML subsystem, the two ML subsystems interchangeably teaching and learning from one another, this is by way of example only. It is understood that the first and second sensors and the first and second teacher/student and student/teacher machine learning subsystems employable thereby may include any suitable types of sensors, including, but not limited to camera, night camera, radar, SAR radar, passive radar, Lidar, gated camera, stereo camera, depth camera, thermal camera, microphone, ultrasound and ECG.

The existence of both instances of teaching and learning exchangedly between the ML subsystems of the camera and radar, or any other suitable sensors employed in the present invention, may happen concurrently or alternatively. The trigger to start one instance and finish another can be a human decision, system decision caused by the interior state of the system or a system decision caused because of external environment change, such as sunset. The process of starting one instance and finishing another may occur repeatedly over time. Once the training phase ends completely, each sensor may be operated separately in inference mode as was previously explained in FIG. 10B.

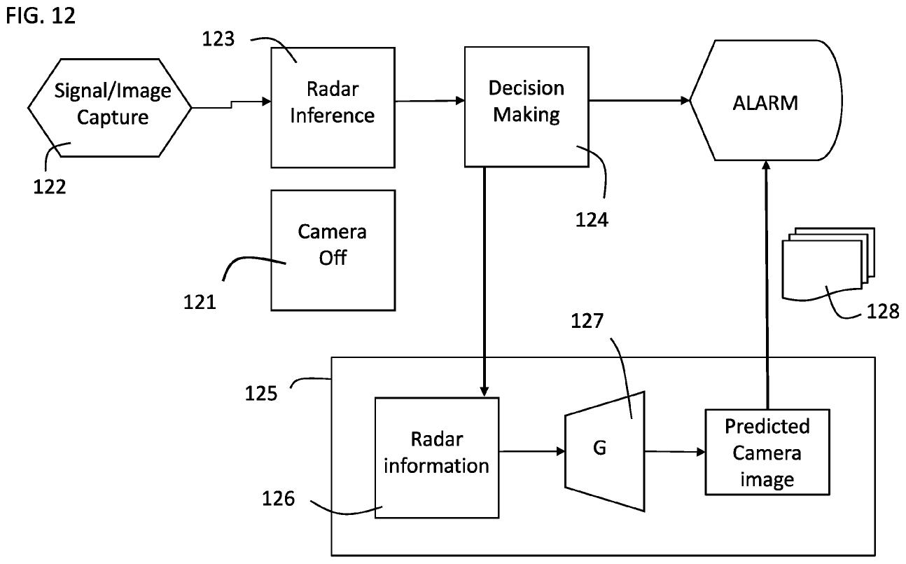

Reference is now made to FIG. 12, which is a simplified flow chart of system alarming process and the information generated in a novel process and presented to the user in case of an alarm. An alarm could be declared as a result of a process run in the sensor level, analyzer level, or at the system level. For instance, the system could be configured to provide an alarm in the case that a human fell off in the area under monitoring. In this figure the system is in operational mode, the training of the radar by the camera concluded, the camera 121 is turned off and only the radar components are active. The radar captures signal, a sequence of signals (e.g. spectrogram), radar outputs, radar image, point cloud, etc. The radar inference 123 is active as well as the decision-making algorithm 124. Based on the training process the ML Model has gone through, it detects the event. The decision-making process may declare an alarm, like in the aforementioned case when a human fell-off in the scene. In that case, the decision-making process also activates a novel process 125 which processes the radar information 126 at the time of the alert and generates a predicted visual image or sequence of images 128 that is associated with the alarm. The image is generated using a novel process that translates signals from one signal domain (radar) to another signal domain (camera), hereinafter our Conditional Dual Domain Generator (cddG) 127. Although the camera is turned off (or in blur mode), the system generates a visual image or sequence of images. The image can be generated even if the human fell-off behind an occluding object and a real camera could not have provided an image even if it was activated. Additionally, the image can be generated such that it still preserves privacy. The system can generate an image that is plausible and explains the event but does not preserve details, such as whether the human is dressed or undressed.

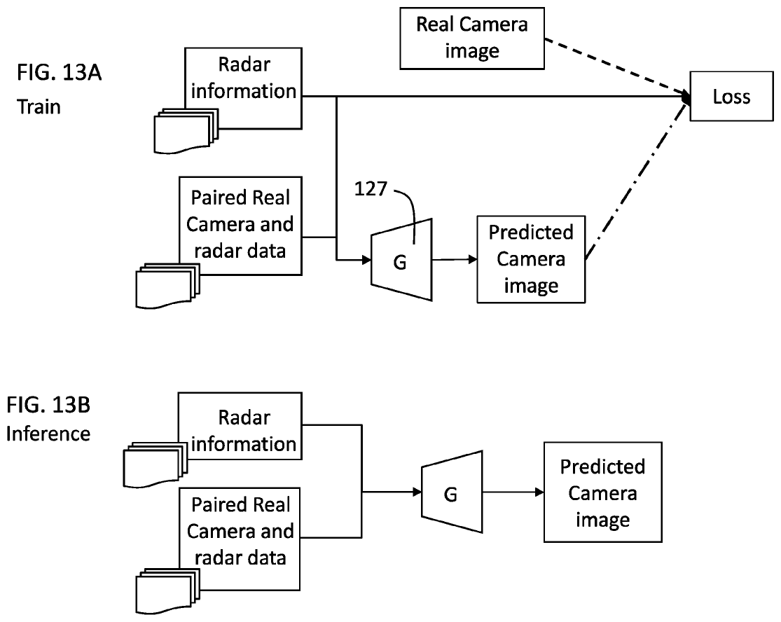

Reference is now made to FIGS. 13A and 13B, which are block diagrams depicting the training and inference process of the generator G 127 as presented in FIG. 12. We propose a novel method to train the generator which is based on data pairs from various time stamps in history. Accordingly, we term the novel network as Conditional Dual Domain history-aware generator GAN (cdd-haG). The generator takes as input a sequence of radar data samples as well as paired data of both camera and radar from previous time in history. This enables the generator to obtain a baseline of how the visual output should look like at all times and which radar input features correspond to what image features. Additionally, the visual image may serve as the basis for the generator manipulation which makes it task more feasible. Thanks to the reasons mentioned above, our novel architecture design succeeds where the naive implementation fails. FIG. 13A represents the training process, in which the generators takes its input and produces a plausible predicted output. Given it's output and the actual ground truth, a loss value is calculated which then serves to train G to predict better output in the future. The actual calculation of the loss value depends on many application-specific details but is generally designed to optimize the likelihood that the predicted output is a plausible sample for the ground-truth distribution. Common choices for the loss may be Autoregressive, Variational AutoEncoder, Normalizing Flows, Continuous Normalizing Flows and Generative Adversarial Networks. FIG. 13B represents the inference process, in which G 127 generates image data from radar data. The camera data and whatever auxiliary information used to calculate the loss are no longer required. Thus, our cdd-haG model allows us to obtain optic, camera-like, information while the camera is closed. Since the generated optic images are plausible but not exact, the essence of the scene is captured (e.g. an elder has fallen), but privacy remains intact (e.g. the elder would have a different face if required).

The cdd-haG, in combination with sensors, may form a sensing system. A sensing system comprising the cdd-haG may include a first sensor sensing first data from a scene and a second sensor sensing second data from the scene, said first data being of a different type than the second data. The first and second sensors may be sensors as described hereinabove, with reference to FIGS. 1-12, employing ML subsystems as described hereinabove. The cdd-haG may be considered to be a Machine Learning Generative Module including a generator sub-module operative to receive first data sensed from the scene and to generate, using machine learning and based on the first data, a representation of the scene corresponding to the second type of data, and a paired data provider operative to provide to the generator sub-module pairs of mutually corresponding first type of data and second type of data previously sensed from the scene, the generator sub-module being operative to take into account the pairs of mutually corresponding previously sensed first and second types of data in generating the representation of the scene.

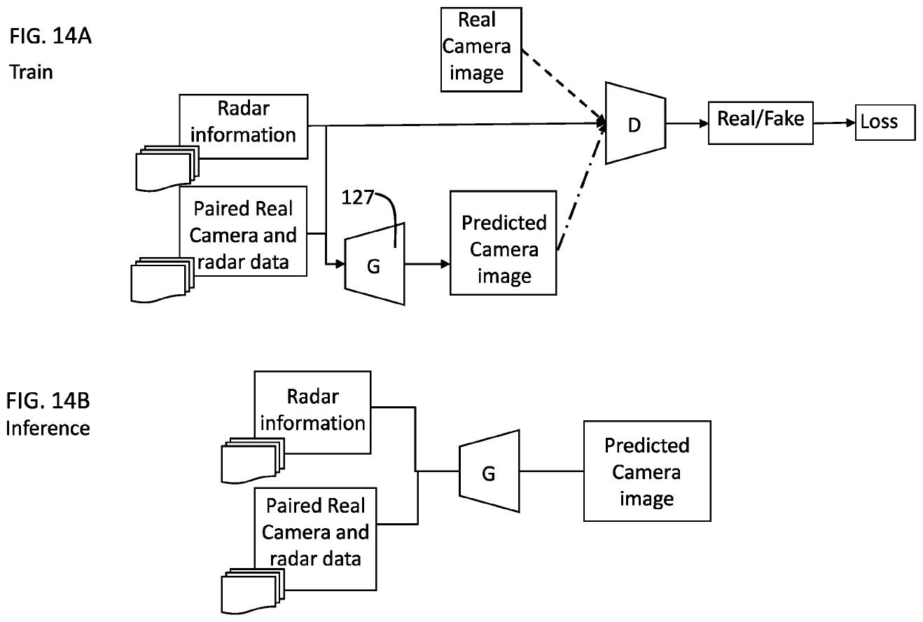

Reference is now made to FIGS. 14A and 14B, which are block diagrams depicting an example of a training and inference paradigms for our cdd-haG. In this example, the generator is trained specifically using a two-player minimax loss, deriving from conditional Generative Adversarial Networks (cGANs). Again, FIG. 14A represents the training process and FIG. 14B representing the inference process. A cGAN consists of two Deep Neural Networks (DNNs)—a Generator, marked G, and a Discriminator, marked D. D can be considered as an auxiliary DNN that serves to compute the aforementioned minimax loss. During training, G is trained to translate radar information to “fake” camera information, corresponding to its input radar information. G is trained such that the generated data is plausible, but not exact. On the other hand, D gets as input: either (real radar, real camera) or (real radar, fake camera-generated by G) and is trained to distinguish between real and fake pairs. The two networks are trained in an adversarial manner, where G is trying to fail D's ability to distinguish. Then G is trained to generate image data (i.e. camera like image and video), from radar data and information. As can be seen in FIG. 14B the inference process does not change, as the specific choice of cGAN and minimax loss only affects the training process.

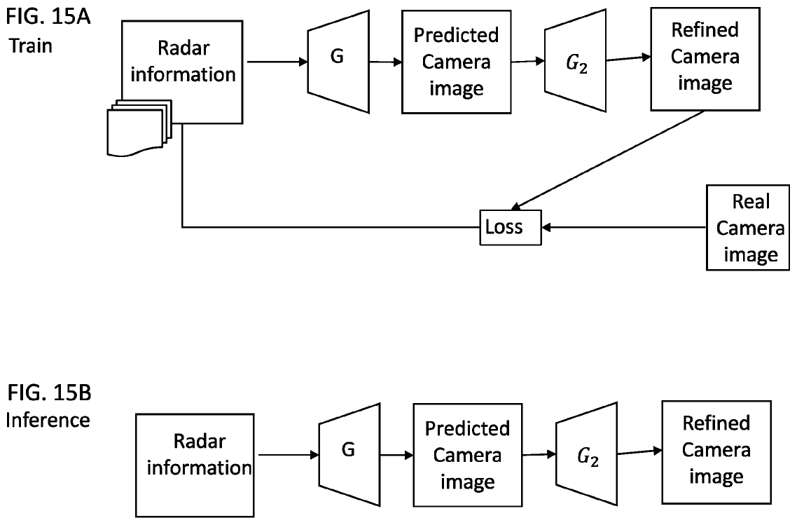

Reference is now made to FIGS. 15A and 15B, which are block diagrams depicting an additional possible implementation for cddG which we call Conditional Dual Domain Generator on Generator or cddG 2. cddG 2 may be used on its own or together with cdd-haG as introduced by FIGS. 14A and 14B. As before, FIG. 15A depicts the training procedure while FIG. 15B depicts the inference procedure. Our generator is tasked with an incredible hard task of translating radar signals into a visual, realistic image. To ease the task we practically divide it into two or more steps. In the first step, the generator is already tasked with translating radar signals to visual image, as usual. However, its output image is not used as the final output, but goes into an additional generator which is responsible to produce realistic, high-quality visual images. As before, a loss function is calculated using the predicted image, the ground truth image as well as the radar input. Several loss functions may be a good fit and the best choice is application-specific. As can be seen in FIG. 15B, during inference the radar signal is forwarded through both generators to produce the final output. The second generator may perform relatively minor changes to its input or generate an entirely new image, it has the inherent ability to perform both, and the decision of optimal behavior is determined by the training process. It is appreciated that the entirely new image may be non-additive, meaning the new image generated by the second generator is not simply additive with respect to the image input thereto but rather generated anew by the second generator. As mentioned before, in some cases where the data provided causes the generation task to be more difficult, we employ further consecutive generators operating each on its predecessor's input, each consecutive generator operating as described above with respect to the second generator, thus forming an extended architecture we call cddG².

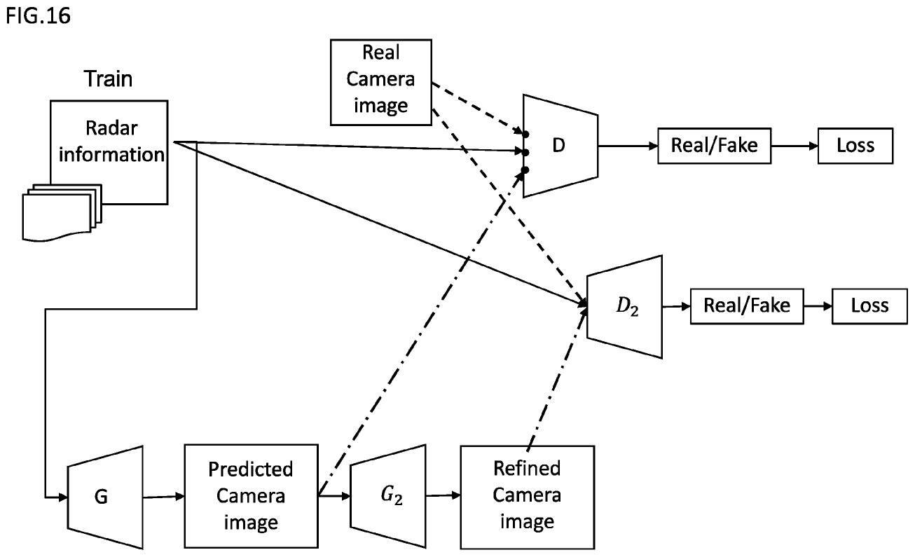

The cddG², in combination with sensors, may form a sensing system. A sensing system including the cddG² may include a first sensor sensing first data from a scene, and a second sensor sensing second data from the scene, the first data being of a different type than said second type of data. The first and second sensors may be sensors as described hereinabove, with reference to FIGS. 1-12, employing ML subsystems as described hereinabove. The system may further include a Machine Learning Generative Module including a first generator sub-module operative to receive the first data and to generate, using machine learning and based on the first data, a representation of the scene corresponding to the second type of data; and a second generator sub-module operative to receive the representation of the scene generated by the first generator sub-module and the first data and to generate, using machine learning, a refined representation of the scene corresponding to the second type of data, based on the representation of the scene generated by the first generator sub-module and the first data. Reference is now made to FIG. 16, which is a block diagram depicting an example of a training and inference paradigms for our cddG 2. In this example, the two generators are trained specifically using a two-player minimax loss, deriving from conditional Generative Adversarial Networks (cGANs). Each generator is trained using the minimax loss against a dedicated discriminator, so it performs best effort to produce high-quality, realistic visual images. As with cdd-haG, the choice of loss function and use of auxiliary discriminator affect the training process only and the inference process is left intact. As seen in FIG. 16, the system may include two discriminators. Alternatively, the system may include only a single discriminator, receiving the output of the second generator and the real camera image.

It is understood that the various types of ML generative modules described herein may be useful in a variety of machine learning contexts and are not limited to use within the sensor systems and methods of the present invention. However, the ML generative modules, either alone or in combination with one another, find particular utility in the sensor systems and methods of the present invention, and may be combined with the teacher/student and student/teacher ML subsystems of the present invention, including all or some of the functionalities thereof described hereinabove. Furthermore, it is understood that in some embodiments of the present invention the ML generative modules described herein above may be used to synthesize labelled training data, which labelled training data may be used for the further training of the machine learning subsystems employed by the sensors of the present invention.

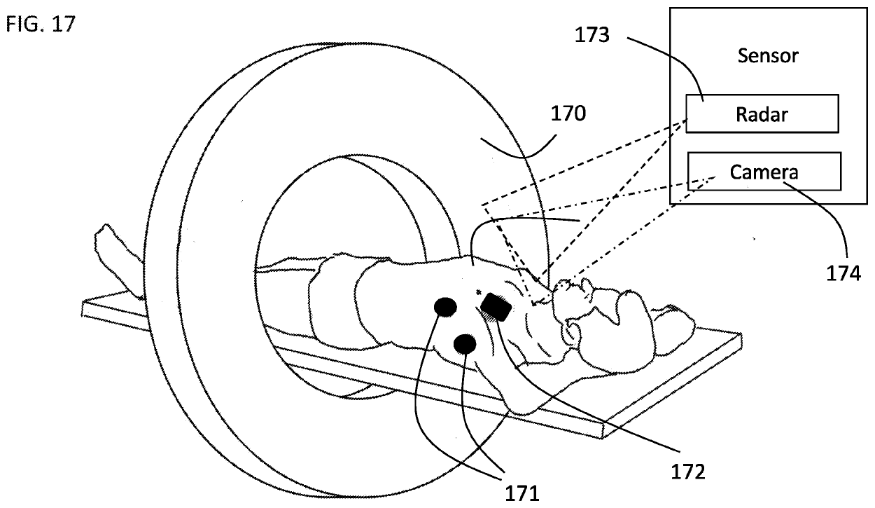

Reference is now made to FIG. 17 which depicts a scene in which a person is under a medical imaging device 170 such as CT or MRI scan and additionally ECG monitoring 171 and imaging device such as Ultrasound sensor 172 are attached to his body. Additionally, in proximity, there are radar 173 and camera 174 sensors that are also monitoring the person movement and physiological parameters.

The CT/MRI provides a high-resolution 3D model of the body or area under scan. The ECG monitors its heart signals which are represented in a 2D signals and the ultrasound generates a 2D or 3D information and doppler. The radar provides a signal that monitors the entire body movement but also physiological parameters like respiration. The camera provides inter alia 2D or 3D image and this data can be analyzed for recognition of the person and his pose and movement.

CT/MRI scans are commonly used for pinpoint detection of objects inside the body, for example tumors. But remaining under a CT/MRI scan causes great radiation exposure and is also expensive. For this end, we employ four additional sensors to perform tracking of the detected object. Then, the pinpoint detection could be tracked and used after some time and even despite changes in posture, location, and physiological parameters of the person. The ultrasound and ECG are attached to the person's body and can track the detection over time. In this example, the ultrasound and ECG may serve as the teachers of the radar and camera. This teacher-student relationship has two purposes. First, camera and radar are remote sensors and are more convenient to use than body-attached sensors such as ultrasound and ECG. Additionally, ultrasound has limited penetration ability as compared to the radar. For example, an ultrasound signal does not penetrate through the lung, but a radar does. Therefore, the ultrasound may serve as a teacher of the radar for tracking purposes on regions it can observe, and then the radar is able to generalize well. Eventually, when the CT/MRI detects an object within the lung, the radar is able to track it.

It will be appreciated by persons skilled in the art that the present invention is not limited by what has been described hereinabove. Rather the present invention includes both combinations and sub-combinations of features described hereinabove as well as modifications thereof which are not in the prior art.

1. A sensing system comprising:
at least a first sensor sensing first data from a scene;
at least a second sensor sensing second data from said scene;
a first teacher/student machine learning subsystem employable by said first sensor to process said first data; and
a second student/teacher machine learning subsystem employable by said second sensor to process said second data,
said first teacher/student machine learning subsystem being operative to teach said second student/teacher machine learning subsystem in a first instance, and
said second student/teacher machine learning subsystem being operative to teach said first teacher/student machine learning subsystem in a second instance.

2. The sensing system of claim 1, wherein said first and second instances occur at least one of sequentially, partially concurrently and repeatedly over time.

3. The sensing system of claim 1, and also comprising at least one additional student/teacher machine learning subsystem,
said first teacher/student machine learning subsystem being operative to teach said at least one additional student/teacher machine learning subsystem in a third instance,
said at least one additional student/teacher machine learning subsystem being operative to teach said second student/teacher machine learning subsystem in a fourth instance.

4. The sensing system of claim 1, wherein, upon said second student/teacher machine learning subsystem achieving a pre-determined performance, said first sensor is deactivated and said first teacher/student machine learning subsystem is operative to stop teaching said second student/teacher machine learning subsystem.

5. The sensing system of claim 1, wherein, in said first instance, said first teacher/student machine learning subsystem is operative to teach said second student/teacher machine learning subsystem to automatically label said second data and, in said second instance, said second student/teacher machine learning subsystem is operative to teach said first teacher/student machine learning subsystem to automatically label said first data, said first and second data being mutually calibrated with respect to one another in each of said first and second instances.

6. The sensing system of claim 1, wherein said at least first and second sensors comprise mutually different types of sensors.

7. The sensing system of claim 6, wherein said at least first and second sensors comprise at least one of the following:
one of said first and second sensors is a camera and the other one of said first and second sensors is an active or passive radar;
one of said first and second sensors is an active radar and the other one of said first and second sensors is a passive radar; and
one of said first and second sensors is an ultrasound sensor and the other one of said first and second sensors is an ECG sensor.

8. The sensing system of claim 1, wherein at least one of said at least first and second sensors is a remote sensor.

9. The sensing system of claim 1 and also comprising a Machine Learning Generative Module, operative to receive said data sensed by one of said first and second sensors and to generate, using machine learning and based on said received data, a generated representation of said scene corresponding to data sensed by the other one of said first and second sensors.

10. The sensing system according to claim 9, wherein said Machine Learning Generative Module comprises a Generative Adversarial Network (GAN).

11. The sensing system according to claim 10, wherein said GAN is a conditional GAN.

12. The sensing system of claim 9, wherein said Machine Learning Generative Module comprises:
a generator sub-module operative to receive said data sensed by said one of said first and second sensors and to generate, using machine learning and based on said data sensed by said one of said first and second sensors, said representation of said scene corresponding to said data sensed by said other one of said first and second sensors; and
a paired data provider operative to provide to said generator sub-module pairs of mutually corresponding data previously sensed from said scene by said first and second sensors, said generator sub-module being operative to take into account said pairs of mutually corresponding previously sensed data in generating said representation of said scene.

13. The sensing system of claim 9, wherein said Machine Learning Generative Module comprises:
a first generator sub-module operative to receive said data sensed by said one of said first and second sensors and to generate, using machine learning and based on said data sensed by said one of said first and second sensors, said representation of said scene corresponding to said data sensed by said other one of said first and second sensors; and
a second generator sub-module operative to receive said representation of said scene generated by said first generator sub-module and said data sensed by said one of said first and second sensors and to generate, using machine learning, a generated refined representation of said scene corresponding to said data sensed by said other one of said first and second sensors, based on said representation of said scene generated by said first generator sub-module and said data sensed by said one of said first and second sensors.

14. The sensing system of claim 13, wherein said refined representation of said scene generated by said second generator sub-module is newly generated with respect to said representation of said scene generated by said first generator sub-module.

15. The sensing system of claim 13, and also comprising at least one additional generator sub-module operative to receive said refined representation of said scene generated by said second generator sub-module and said data sensed by said one of said first and second sensors and to generate, using machine learning, a further refined representation of said scene corresponding to said data sensed by said other one of said first and second sensors, based on said refined representation of said scene generated by said second generator sub-module and said data sensed by said one of said first and second sensors.

16. The sensing system of claim 9, wherein said Machine Learning Generative Module is operative to synthesise labelled training data useful for the training of at least one of said first and second machine learning subsystems.

17. A sensing system comprising:
at least a first sensor sensing first data from a scene;
at least a second sensor sensing second data from said scene, said first data being of a different type than said second data; and
a Machine Learning Generative Module comprising at least one of:
(i) a generator sub-module operative to receive said first data sensed from said scene and to generate, using machine learning and based on said first data, a representation of said scene corresponding to said second type of data, and a paired data provider operative to provide to said generator sub-module pairs of mutually corresponding first type of data and second type of data previously sensed from said scene, said generator sub-module being operative to take into account said pairs of mutually corresponding previously sensed first and second types of data in generating said representation of said scene, and
(ii) a first generator sub-module operative to receive said first data and to generate, using machine learning and based on said first data, a representation of said scene corresponding to said second type of data, and a second generator sub-module operative to receive said representation of said scene generated by said first generator sub-module and said first data and to generate, using machine learning, a refined representation of said scene corresponding to said second type of data, based on said representation of said scene generated by said first generator sub-module and said first data.

18. The sensing system according to claim 17, wherein said Machine Learning Generative Module comprises a Generative Adversarial Network (GAN).

19. The sensing system of claim 17, and also comprising at least one additional generator sub-module operative to receive said refined representation of said scene generated by said second generator sub-module and said first data and to generate, using machine learning, a further refined representation of said scene corresponding to said second type of data, based on said refined representation of said scene generated by said second generator sub-module and said first data.

20. The sensing system of claim 17 and also comprising:
a first teacher/student machine learning subsystem employable by one of said first and second sensors to process said data sensed thereby; and
a second student/teacher machine learning subsystem employable by the other one of said first and second sensors to process said data sensed thereby,
said first teacher/student machine learning subsystem being operative to teach said second student/teacher machine learning subsystem in a first instance, and
said second student/teacher machine learning subsystem being operative to teach said first teacher/student machine learning subsystem in a second instance.

21. (canceled)
